(19) United States
(12) Patent Application Publication
(10) Pub. No.: US 2012/0089983 A1
(43) Pub. Date: Apr. 12, 2012

(54) ASSESSING PROCESS DEPLOYMENT

(75) Inventors: Arunava Chandra, Salt Lake City (IN); Pradip Pradhan, Salt Lake City (IN); Balakrishnan Subramani, Karapakkam (IN); Kamna Tyagi, Gomti Nagar (IN); Nina Modi, Mumbai (IN); Jyoti Mohile, Mumbai (IN); Alka Chawla, New Delhi (IN); Sandeep Rekhi, New Delhi (IN); Sandhya Kakkar, New Delhi (IN); Vasu Padmanabhan, Chennai (IN)

(73) Assignee: Tata Consultancy Services Limited, Mumbai (IN)

(21) Appl. No.: 13/236,745

(22) Filed: Sep. 20, 2011

(30) Foreign Application Priority Data
Oct. 11, 2010 (IN) 2814/MUM/2010

(51) Int. Cl. G06F 9/46

(52) U.S. Cl. 718/100

(57) ABSTRACT

System and methods for assessing process deployment are described. In one implementation, the method includes collecting at least one metric value associated with at least one operating unit within an organization. Further, the method describes normalizing the at least one collected metric value to a common scale to obtain normalized metric values. The method further describes analyzing the metric value to calculate a process deployment index which indicates the extent of deployment of the one or more processes within the organization.

### CLAIM OF PRIORITY

This application claims the benefit of priority under 35 U.S.C. §119 of Arunava Chandra et al., Indian Patent Application Serial Number 2814/MUM/2010, entitled “ASSESSING PROCESS DEPLOYMENT,” filed on Oct. 11, 2010, the benefit of priority of which is claimed hereby, and which is incorporated by reference herein in its entirety.

### TECHNICAL FIELD

The present subject matter relates, in general, to systems and methods for assessing deployment of a process in an organization.

### BACKGROUND

An organization typically has multiple operating units, each having a specific set of responsibilities, and a business objective. The operating units deploy different processes to meet their specific business objectives. A process is generally a series of steps or acts followed to perform a task. Some processes may be common to some or all operating units, while some processes may be unique to a particular operating unit depending on the functioning of the unit. Processes may also be provided for different functional areas like Sales & Customer Relationship, Delivery, Leadership & Governance, Information Security, Knowledge Management and so on. In an organization use of standard set of processes helps in streamlining activities, and ensures a consistent way of performing different functions thereby reducing the risk and generating predictive outcome. Furthermore such processes may also facilitate performing functions of different roles across the organization to generate one or more predictive outcomes.

In order to assess the rigor of deployment and compliance of the processes, organizations may conduct regular audits of the organizational entities and detect the deviations. This can be accomplished by various systems that implement process audit mechanisms for checking compliance with one or more organizational polices.

The deployment of a process in an organization generally refers to the extent to which the process is implemented and adhered to during the normal course of working of the organization. Deployment of processes in an organization is typically impacted by different factors, such as structure of the organization, different types of operating units, project life-cycles, and project locations. There are various tracking or review mechanisms available to assess the extent and rigor of deployment of processes. Though these mechanisms are able to identify areas of strengths and weakness but are not much effective to clearly indicate the extent of deployment of one or more processes within the organization.

### SUMMARY

This summary is provided to introduce concepts related to assessment or deployment of processes in an organization, which are further described below in the detailed description. This summary is not intended to identify essential features of the claimed subject matter nor is it intended for use in determining or limiting the scope of the claimed subject matter.

In one implementation, the method includes collecting at least one metric value associated with at least one operating unit within an organization. Further, the method describes normalizing the at least one collected metric value to a common scale to obtain normalized metric values. The method further describes analyzing the metric value to calculate a process deployment index which indicates the extent of deployment of the one or more processes within the organization.

### BRIEF DESCRIPTION OF THE DRAWINGS

The detailed description with reference to the accompanying figures is provided. In the figures, the left-most digit(s) of a reference number identifies the figure in which the reference number first appears. The same numbers are used throughout the drawings to reference like features and components.

FIG. 1 illustrates an exemplary computing environment implementing a process evaluation system for assessment of process deployment, in accordance with an implementation of the present subject matter.

FIG. 2 illustrates exemplary components of a process evaluation system, in accordance with an implementation of the present subject matter.

FIG. 3 illustrates an exemplary method to assess the deployment of processes in an organization, in accordance with an implementation of the present subject matter.

FIG. 4 illustrates an implementation of a process deployment index (PDI) Dashboard, in accordance with an implementation of the present subject matter.

FIG. 5 illustrates another implementation of the PDI Dashboard, in accordance with an implementation of the present subject matter.

FIG. 6 illustrates an exemplary method to evaluate a process readiness index in an organization, in accordance with an implementation of the present subject matter.

### DETAILED DESCRIPTION

A process is typically a series of steps that are planned to be performed so as to achieve one or more identified business objectives. An organization generally deploys multiple processes to achieve the business objectives in a consistent and efficient manner. The efficiency and profitability of the organization, in most cases, depend on the maturity and deployment of the processes. Process deployment takes into consideration various aspects including readiness, coverage, rigor and effectiveness of a process. For example, readiness of a process deployment can be indicated by an assessment of whether the process is ready to be deployed, and is dependant on multiple factors. Coverage of process deployment refers to an extent to which the process is rolled-out in the organization. This can include, for example, the number of people using the process and the number of people aware of the process. Rigor of a process deployment refers to an extent to which the process is institutionalized and has become a part of routine activities. Effectiveness of deployment of a process refers to an extent to which the process is being followed so that it meets the intended business objective.

In conventional systems, to assess process deployment, different parameters or metrics are evaluated for different processes. Since the metrics are composed of different variables of a process, the scale of assessment or the unit of measurement of these metrics also varies for different metrics. As a result, the process deployment status for each process would be assessed and reported differently, and a meaningful comparison of deployment across various processes becomes difficult. Further, the assessment carried out for the different processes is typically specific to a process area and therefore is not totally reliable and unable to provide overall status of deployment across different process areas.

To this end, systems and methods for assessing process deployment are described. In one implementation, for the harmonized assessment and representation of the deployment of different processes in an organization, a process deployment index (PDI) may be used. Such representations facilitate identification of areas, where improvements may be required. Once such areas are identified, necessary corrective or preventive actions can be taken. The PDI can be computed for a metric, for a process area, or an operating unit or the entire organization from the different metrics corresponding to the different processes. These metrics have different units of representation. For example, different measures for a particular process area can be percentage of projects completed, number of trained employees, etc. Also measures for processes of a particular process area may or may not be applicable to all operating units. In one implementation, a matrix may be prepared listing different measures for the different processes and applicability of these measures to different operating units.

In an embodiment, an operating unit may be a logical or a functional group responsible for providing services to the customers of different domain, for example an industry domain, a major market segment, a strategic market segment, a distinct service sector and a technology solution domain. The particular industry domain includes banking, finance, manufacturing, and retail. The major market segment may also include different countries like USA, UK, Europe, etc., and strategic market segment includes new growth Market, and Emerging market. The distinct service sector may include BPO, Consulting, and Platform BPO and technology solution domain include SAP, BI, Oracle Applications etc. Once the metrics are defined for different processes, the metrics are collected from the different operating units. As discussed earlier, the metrics may have different unit of measure e.g., percentage, absolute value, etc. Once collected, the values of different metrics can be normalized to a common scale without affecting the significance of the original values of the metrics. The metrics are then analyzed to calculate the PDI, which can be analyzed to indicate the extent to which the processes have been deployed in the organization.

It would be noted that the PDI indicates an overall status of the deployment of the processes across the organization. As discussed, the PDI can be computed for the entire organization, for different operating units, different process areas, and metrics for specific time periods. In one implementation, the PDI can be displayed through a common dashboard in the form of value, color codes indicating the state, graph, trends etc. Thus, process deployment across various operating units can be effectively collated and compared in a harmonized manner, thereby making the assessment reliable, informative and efficient.

In another implementation, before an operating unit can be included for reporting the metrics and for determination of PDI, a readiness index can be calculated, which indicates the level of readiness of the newly included operating unit. In one implementation, this would include determining conformance of the newly included operating units with one or more basic readiness parameters.

While aspects of described systems and methods for assessing the status of processes can be implemented in any number of different computing systems, environments, and/or configurations, the implementations are described in the context of the following exemplary system(s).

### Exemplary Systems

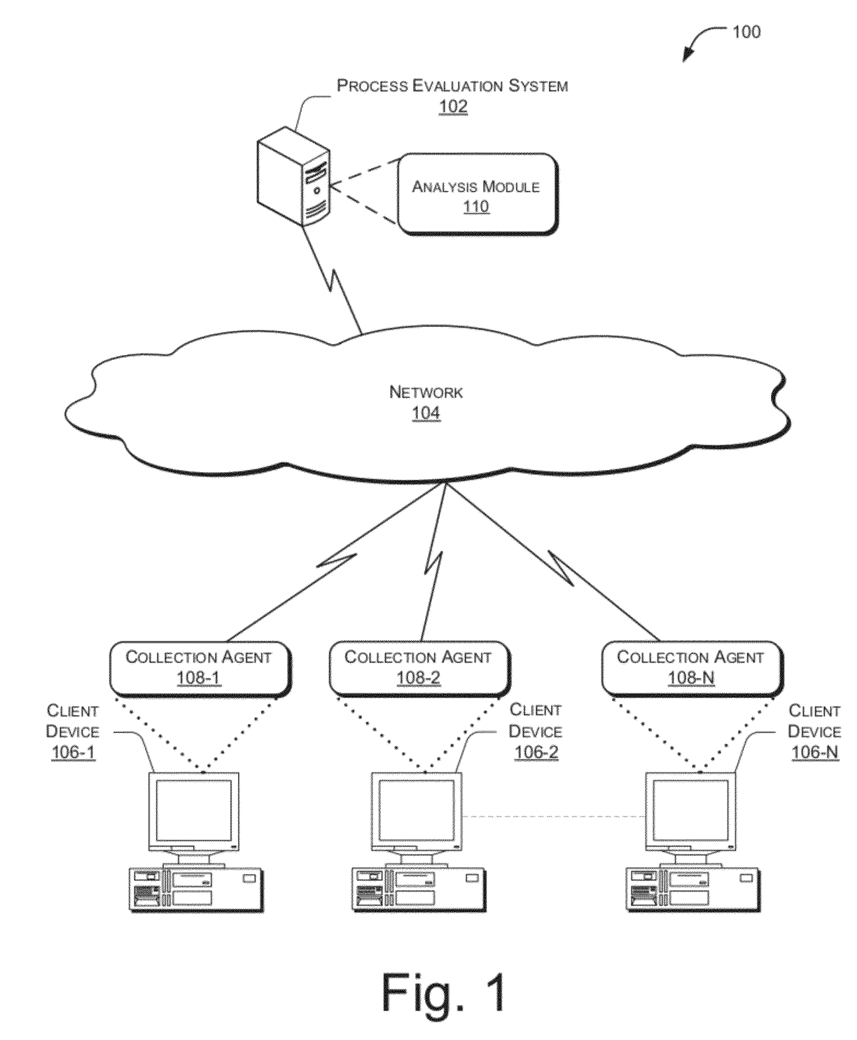

FIG. 1 shows an exemplary computing environment 100 for implementing a process evaluation system to assess process deployment in an organization. To this end, the computing environment 100 includes a process evaluation system 102 communicating, through a network 104, with client devices 106-1, . . . , N (collectively referred to as client devices 106). The client devices 106 include one or more entities, which can be individuals or a group of individuals working in different operating units within the organization to meet their aspired business objectives.

The network 104 may be a wireless or a wired network, or a combination thereof. The network 104 can be a collection of individual networks, interconnected with each other and functioning as a single large network (e.g., the internet or an intranet). Examples of such individual networks include, but are not limited to, Local Area Networks (LANs), Wide Area Networks (WANs), and Metropolitan Area Networks (MANs).

It would be appreciated that the client devices 106 may be implemented as any of a variety of conventional computing devices, including, for example, a server, a desktop PC, a notebook or portable computer, a workstation, a mainframe computer, a mobile computing device, an entertainment device, an internet appliance, etc. For example, in one implementation, the computing environment 100 can be an organizations computing network in which different operating units use one or more client devices 106.

For analysis of different processes implemented by the different operating units, the process evaluation system 102 collects various data or metrics from the client devices 106. In one implementation, analysis of different processes means checking deployment status of different processes in the organization. In one implementation, each of the client devices 106 may be provided with collection agent 108-1, 108-2 . . . 108-N, respectively. The collection agent 108-1, 108-2 . . . 108-N (collectively referred to as collection agents 108) collect the data or metrics related to different processes deployed through the computing environment 100.

The collection agents 108 can be configured to collect the metrics related to different processes automatically. In one implementation, one or more users can upload the metrics manually. In one implementation, a user may directly enter data related to the different processes through a user interface of the client devices 106, and the data may then be processed to obtain the metrics. The processing of the data may be performed at any of the client devices 106 or at the process evaluation system 102. In such a case, one or more of the client devices 106 may not include the collection agent 108.

In yet another implementation, the metrics related to the different processes may be collected through a combination of automatic collection, i.e., implemented in part by one or more collection agents 108, and entry by a user.

Once collected, the metrics can be verified for completeness and correctness. For example, metric values reported incorrectly by accident can be identified and corrected. In one implementation, the metrics are verified by the process evaluation system 102. The verification of the metric collected from the client devices 106 can either be based on rules that are defined at the process evaluation system 102 or can be performed manually.

Once the metrics are verified, the process evaluation system analyses the metrics to compute a process deployment index, also referred to as PDI, as described hereinafter. To this end, the process evaluation system 102 includes an analysis module 110, which analyzes the metrics of different process areas. In one implementation, the analysis module 110 analyzes the metrics based on one or more specific rules. In another implementation, the analysis module 110 analyzes the metrics based on historical data. The PDI can then be calculated for the assessment of the deployed processes. In another implementation, various rules can be applied to the PDI for further analysis. For example, the analysis of the PDI can be performed using a business intelligence tool.

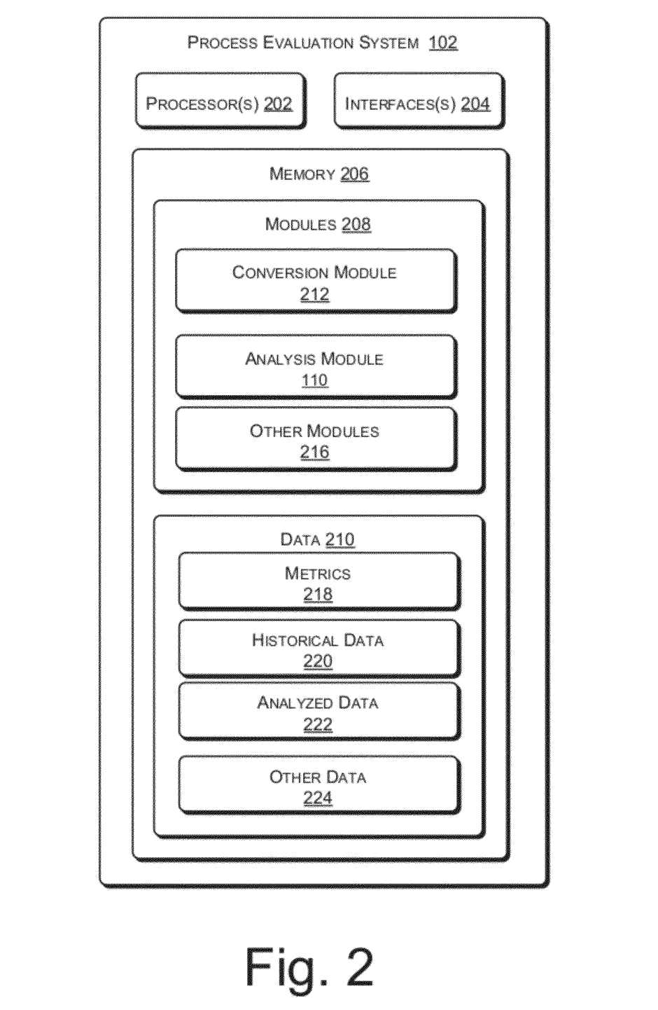

Once calculated, the PDI of different metrics, process areas, operating units, and entire organization and the associated analysis can be displayed on a display device (not shown) associated with the process evaluation system 102. In one embodiment, the analysis can be displayed through a dashboard, referred as PDI Dashboard. The PDI Dashboard and the analytics can be collectively displayed on the display device as a visual dashboard using visual indicators, such as bar graphs, pie charts, color indications, etc. Displaying the PDI associated with the different processes being implemented in an organization, along with the analysis objectively portrays the overall status of deployment of one or more processes in a consolidated and a standardized manner. The manner in which the PDI is calculated is further explained in detail in conjunction with FIG. 2.

The present description has been provided based on components of the exemplary network environment 100 illustrated in FIG. 1. However, the components can be present on a single computing device wherein the computing device can be used for assessing the processes deployed in the organization, and would still be within the scope of the present subject matter.

FIG. 2 illustrates a process evaluation system 102, in accordance with an implementation of the present subject matter. The process evaluation system 102 includes processor(s) 202, interface(s) 204, and a memory 206. The processor(s) 202 are coupled to the memory 206. The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 are configured to fetch and execute computer-readable instructions stored in the memory 206.

The interface(s) 204 may include a variety of software and hardware interfaces, for example, a web interface allowing the process evaluation system 102 to interact with a user. Further, the interface(s) 204 may enable the process evaluation system 102 to communicate with other computing devices, such as the client devices 106, web servers and external repositories. The interface(s) 204 can facilitate multiple communications within a wide variety of networks and protocol types, including wired networks, for example LAN, cable, etc., and wireless networks such as WLAN, cellular, or satellite. The interface(s) 204 may include one or more ports for connecting a number of computing devices to each other or to another server.

The memory 206 can include any computer-readable medium known in the art including, for example, volatile memory (e.g., RAM), and/or non-volatile memory (e.g., EPROM, flash memory, etc.). In one implementation, the memory 206 includes module(s) 208 and data 210. The module(s) 208 further include a conversion module 212, an analysis module 110, and other module(s) 216. Additionally, the memory 206 further includes data 210 that serves, amongst other things, as a repository for storing data processed, received and generated by one or more of the module(s) 208. The data 210 includes, for example, metrics 218, historical data 220, analyzed data 222, and other data 224. In one implementation, the metric 218, the historical data 220, and the analyzed data 222, may be stored in the memory 206 in the form of data structures. In one implementation, the metrics received or generated by the process evaluation system 102 are stored as the metrics 218.

The process evaluation system 102 assesses the status of deployment of processes in an organization or an enterprise by analyzing the metrics 218. The different processes implemented in the organization may relate to various process areas, examples of which include but are not limited to, Sales and Customer Relationship, Leadership and Governance, Delivery, Information Security, Knowledge Management, Process Improvement, Audit and Compliance, etc. The metrics 218 associated with the different processes may therefore have a variety of units of assessment or scales. For example, in one case, the metric 218 may be in the form of an absolute numerical value. In another case, the metric 218 may be in the form of a percentage. Once collected, the metrics 218 can be verified for completeness and correctness by the analysis module 110. For example, metric values reported incorrectly by accident can be identified and corrected. The metrics 218 can be verified by the analysis module 110 based on one or more rules, such as rules defined by a system administrator. The analysis module 110, in such a case, can verify the completeness and consistency of the metrics 218 reported by the client devices 106. Consider an example where one of the metrics 218 was incorrectly reported as 5% as opposed to 55% that was intended to be reported through the client device 106. In such a case, the analysis module 110 can measure the deviation of the reported metrics 218 from the trend of previously reported metrics, stored in the historical data 220. If the deviation exceeds a predefined threshold, the analysis module 110 can identify the 5% reported as a probable incorrect data. In one implementation, the analysis module 110 can be configured to prompt the user to either confirm the value of the metric reported or can request the metrics 218 to be provided again. It would be appreciated that other forms of verification can further be implemented which would still be within the scope of the present subject matter. In another implementation, the verification of the metric collected from the client devices 106 can be performed manually.

In order to analyze the different processes, the conversion module 212 normalizes the metrics 218 for different processes. In one implementation, the conversion module 212 normalizes the metrics 218 based on a common scale, such as a scale of 1-10 where values from 1 to 4 represent RED performance band, 4 to 8 represent AMBER band and 8-10 GREEN band. In one implementation, the metrics 218 may be converted to the common scale by dividing an original scale of the metrics into multiple ranges and mapping these ranges to corresponding ranges of the common scale so that performance bands of both the scales map with each other. For example, a metric that is originally in the percentage scale can be converted to a common scale by mapping an original value between 80%-100% to values in the range of 8-10 of the common scale. Similarly, original values between 40%-80% can be associated to values in the range of 4-8 and original values less than 40% can be mapped to values less then 4. In another example, where a metric value is represented by a numeric and ranging between 0 to 5, values between 0 to 2 can be mapped to 1-4 of the common scale, values greater than 2 to 4 can be mapped to 5-8 of the common scale and values more than 4 can be mapped to common scale's values 9-10. Similarly, other scales of the metrics 218 can be also converted to a common unit of measurement. In one implementation, the normalized metrics values are stored in metrics 218.

Once the scales of the metrics 218 have been obtained, the different ranges within the common scale of 1-10 can be associated with different visual indicators to display the status of deployment of a certain process, say within an operating unit or for a process area or for the entire organization. For example, the values 8-10 may be represented by a GREEN colored indicator indicating an above average or desirable extent of deployment for a process under consideration, values between 4-8 may be represented by an AMBER colored indicator indicating an average extent of deployment and values below 4 may be represented by a RED colored indicator would indicate a below average deployment of the process.

Once the metrics 218 are converted by the conversion module 212, the analysis module 110 receives the converted metrics from conversion module 212. The analysis module 110 analyzes the converted metrics to calculate the process deployment index (PDI) for a process or an operating unit or a process area or for the organization. As described previously, the PDI indicates the extent of the deployment of one or more processes in an organization. In one implementation, the PDI is calculated using the following formula:

$$PDI = \frac{\sum Xi}{No . of Metrics * 10}$$

where Xi is the value of the metric ‘i’.

The PDI can be calculated for a particular process, a particular operating unit, a particular process area, or for the organization for a particular time period. In one implementation, the analysis module 110 displays the PDI through a dashboard in a variety of visual format. For example, in one implementation, the PDI is represented as a value on the scale of 1-10. In another implementation, the PDI may be displayed in the form of colored ranges having a GREEN, AMBER or RED color. In one implementation, the analysis module 110 may further analyze the obtained PDI. For example, the analysis module 110 may represent the PDI in the terms of statistical analysis of data such as variations and mean trends. The representation of the PDI in such a manner can be based on one or more analysis rules. The PDI value provides information on extent to which a process is deployed in the organization and can also be used to assess the areas of improvement.

In another implementation, the analysis module 110 can further analyze the PDI obtained based on the historical data 220. In such a case, the analysis module 110 can be further configured to provide a comparative analysis between the PDI calculated over a period of time. It would be appreciated that such an analysis can provide further insights into the trend of extent of deployment of one or more processes and their improvement over a period of time.

In another implementation, the metrics 218 associated with various processes being implemented in the organization can be reported by a group of individuals or practitioners within an operating unit that is implementing one or more processes under consideration. In another implementation the metrics 218 can be reported to a group of individuals responsible for the process deployment and for providing support to the operating units towards effective process deployment. In one implementation, the PDI is displayed to relevant stakeholders at the organizational level for assessing the extent of deployment of processes across different operating units and to identify generic as well as specific opportunities of improvement.

In another implementation, before an operating unit can be included for reporting the metrics and for determination of PDI, a readiness index can be evaluated which indicates the level of maturity of a newly included operating unit. In one implementation, this would include determining conformance of the newly included operating units with one or more basic compliance parameters related to readiness check. For example, a readiness index, or a process readiness index (hereinafter referred to as PRI) can also be evaluated by the analysis module 110.

To this end, the analysis module 110 can calculate the PRI based on the metrics 218. In one implementation, the PRI can be calculated based on the following equation:

$$\frac{\sum Xi * 100}{No . of Metrics}$$

where Xi is the value of the Readiness metric ‘i’.

Once the PRI is determined, the analysis module 110 can compare the calculated PRI with one or more threshold parameters. In one implementation, threshold parameter may have GREEN, AMBER and RED ranges indicating good, fair and poor status respectively. If the analysis module 110 determines that the PRI is within the limits defined by the threshold parameters and the unit stabilizes on that PRI for some period of time, it may subsequently consider evaluating PDI for the newly added operating unit.

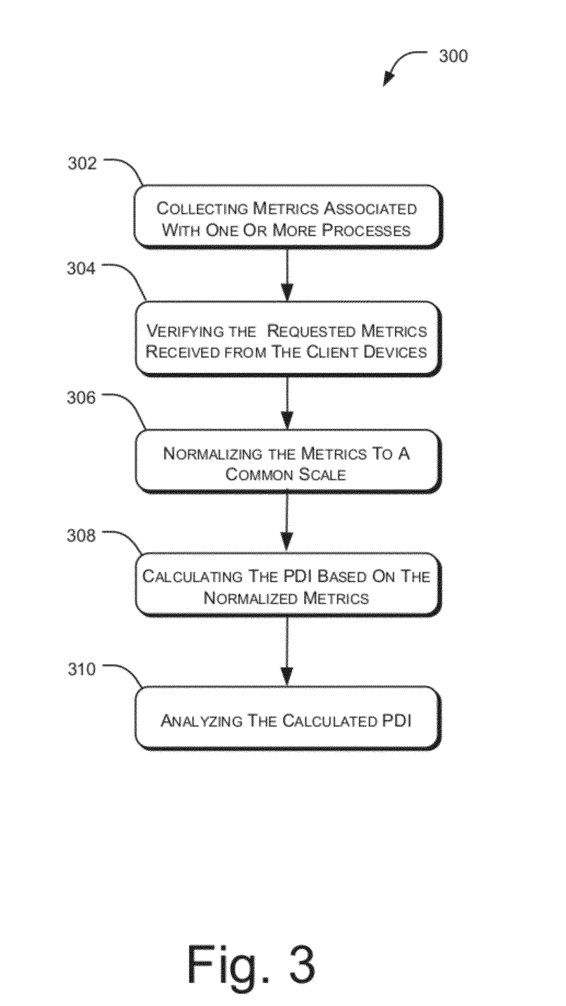

FIG. 3 illustrates an exemplary method 300 for calculating the process deployment index of an organization. The order in which the method is described is not intended to be construed as a limitation, and any number of the described method blocks can be combined in any order to implement the method, or an alternative method. Additionally, individual blocks may be added to or removed from the method without departing from the spirit and scope of the subject matter described herein. Furthermore, the methods can be implemented in any suitable hardware, software, firmware, or combination thereof.

At block 302, process indicators or metrics associated with one or more processes are collected. For example, the process evaluation system 102 collects the metrics from collection agents 108 within one or more client devices 106. The collection agents 108 can either report the metrics related to different processes in a predefined automated manner, or can be configured to allow one or more users to upload the metrics manually, say through user-interfaces, templates, etc.

At block 304, the reported metrics are verified. For example, the analysis module 110 can verify the metrics 218 provided, say by the client devices 106, or as collected by the collection agents 108 based on one or more rules. In one implementation, the analysis module 110 can be configured to prompt the user to either confirm the value of the metrics 218 reported or correct the metric 218 reported, as required. It would be appreciated that other forms of verification can also be contemplated which would still be within the scope of the present subject matter. In another implementation, the verification of the metric collected from the client devices 106 can be performed manually. In another implementation, a value that is not reported is provided a default score.

At block 306, the metrics are normalized. For example, the metrics 218 can be normalized to a common scale by the conversion module 212. In one implementation, the metrics 218 may be converted to the common scale by logically dividing an original scale of the metrics into multiple ranges and associating the different ranges of the original scale with a corresponding range of the common scale. Furthermore, different ranges within the scale of 1-10 can be associated with different visual indicators, such as color GREEN, AMBER, and RED, to display the performance status of deployment of a certain process.

At block 308, a process deployment index or PDI is calculated based on the normalized metrics. For example, the analysis module 110 calculates the PDI based on the metrics 218 normalized by the conversion module 212. In one implementation, PDI is calculated using the following formula:

$$PDI = \frac{\sum Xi}{No . of Metrics * 10}$$

where Xi is the value of the metric ‘i’.

In one implementation, the PDI is calculated by the analysis module 110 on periodic basis. For example, the analysis module 110 can be configured to provide the PDI on monthly, weekly, quarterly or any other time interval. Furthermore, the PDI can be calculated for one, more, or all process metrics or process areas, or operating units, or the entire organization. For example, the analysis module 110 can be configured to calculate the PDI for different processes areas like sales and relation, delivery, and leadership and governance, and for different operating units like Banking and Financial Services (BFS), insurance, manufacturing, and telecom etc. In one implementation, the metrics related processes considered for PDI may undergo additions or deletions in view of the business objectives of the organizations. Similarly, a process area may be added to or deleted from the purview of PDI if situation demands.

At block 310, the calculated PDI is further analyzed. For example, the PDI is displayed using a visual dashboard with statistical formats indicating trends, distributions, variations depicting the extent of process deployment over a period of time. The representation of the PDI in such a manner can be based on one or more analysis rules. Furthermore, the process evaluation system 102 can be configured to allow a viewer to drill-down to the underlying data by clicking on one or more of the visual elements being displayed on the dashboard. In one implementation, the analysis module 110 can further analyze the PDI obtained based on the historical data 220 to provide a comparative analysis between the PDI calculated for more than one operating units over a period of time, provide one or more alerts associated with the PDI, etc. In one implementation the system can add additional analytics based on requirement.

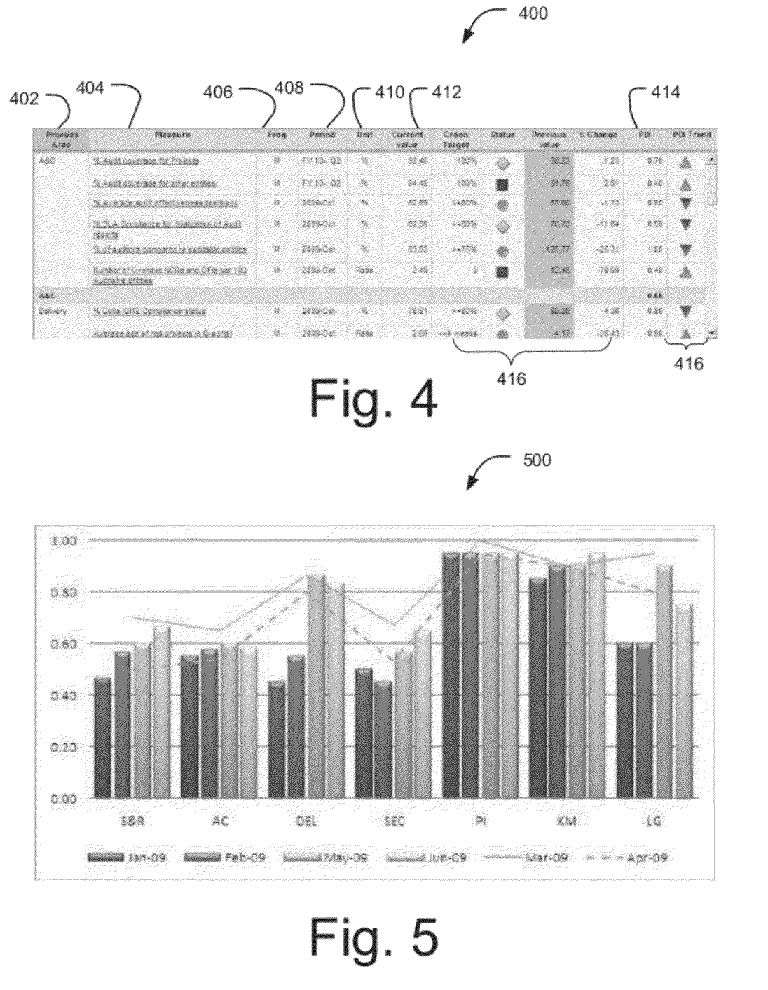

FIG. 4 illustrates an exemplary PDI Dashboard 400, as per one implementation of the present subject matter. As can be seen, the dashboard 400 includes different fields, such as the process area field 402, measures field 404 associated with the process area 402, and frequency 406. The field frequency 406 depicts the duration or the interval, i.e., monthly, at which the data or metrics 218 are collected and published.

The dashboard 400 further includes a period field 408 which indicates the period of metric collection. The unit column 410 displays the unit of measurement for the various metrics 218 that have been reported by one or more of the client devices 106. The field current value 412 indicates the value of the particular metric that has been reported for the period 408. Furthermore, the PDI field 414 indicates the PDI that has been calculated by the analysis module 110 for the metric or process area of that corresponding row.

The dashboard 400 also includes four other fields 416, such as GREEN target column which indicates the target values to be achieved by the corresponding metric in column 404. The status field shows the performance status of the processes under consideration using one or more visual elements such as RED, AMBER, and GREEN. In addition, the previous value field and the % change field indicate the last collected value of the metric 218 and the change in the current value as compared to the previous value, respectively. For example, for the process area A&C (Audit and Compliance) frequency of collection of the last two metrics 218 namely ‘% of auditors compared to auditable entities’ and ‘Number of Overdue NCR's and OFI's per 100 auditable entities’ are shown as monthly. The PDI trend for ‘% of auditors compared to auditable entities’ the second last metrics 218 is downward and that for ‘Number of Overdue NCR's and OFI's per 100 auditable entities’ is upward. The cumulative PDI for the entire process area, i.e., A&C is shown as 0.65.

FIG. 5 illustrates an exemplary graph displaying PDI for various process areas, as per an implementation. As illustrated the graph displays variation in the PDI for processes in one or more process areas for a period of six month. It would be appreciated that the trends can be generated for any time period, based on the preference of a user. As can be seen, different process areas are plotted on the X-axis and their corresponding PDI values are provided along the Y-axis. The values of the PDI are based on a scale of 0.00-1.00. In a similar way, a different scale for indicating the PDI can be used.

As illustrated, the different processes that are plotted include Sales and Customer Relationship (S&R), Audit and Compliance (AC), Delivery (DEL), Information Security (SEC), Process Improvement (PI), Knowledge Management (KM), Leadership and Governance (LG). PDI values for the period of six month are plotted starting from January-09 to June-09. PDI values for January-09, February-09, May-09 and June-09 are plotted in the form of bars. Whereas, PDI values for the months of March-09 and April-09 are plotted in the form of solid and dashed lines, respectively. By plotting this graph comparison of PDI values of one or more process areas over a period of time can be displayed. In one implementation, instead of month PDI values can be plotted on a quarterly or yearly basis. In another implementation, instead of plotting process areas on X-axis, similar plots can also be generated for selective metrics or operating units.

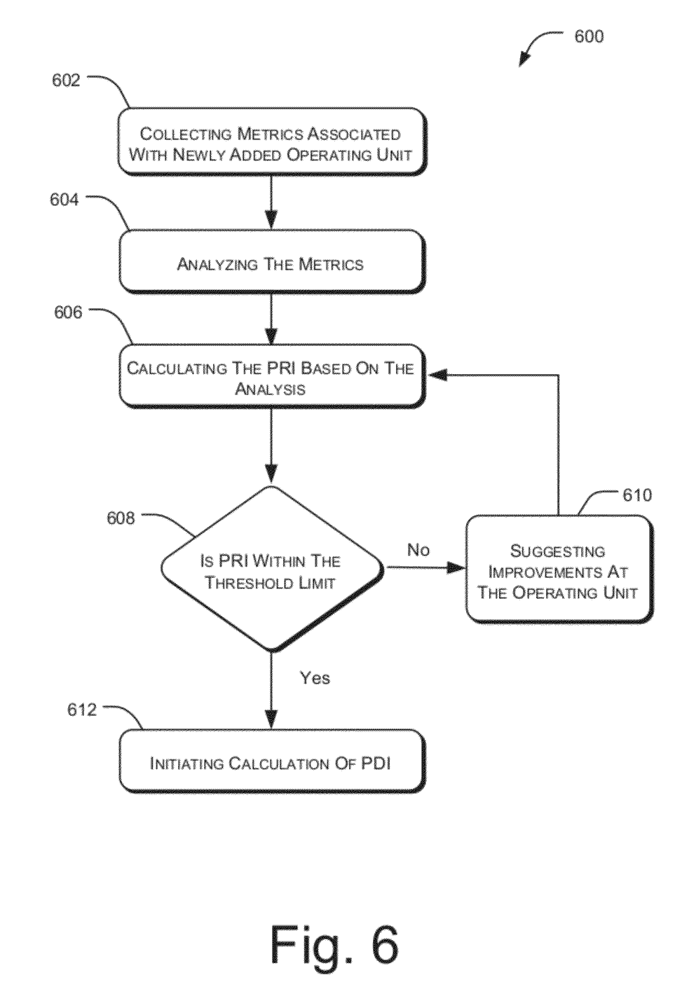

FIG. 6 illustrates an exemplary method 600 for calculating the process readiness index (PRI). The order in which the method is described is not intended to be construed as a limitation, and any number of the described method blocks can be combined in any order to implement the method, or an alternative method. Additionally, individual blocks may be added to or deleted from the method without departing from the spirit and scope of the subject matter described herein. Furthermore, the methods can be implemented in any suitable hardware, software, or combination thereof.

As indicated previously, PRI is calculated whenever a new operating unit is included within an organization. A favorable value of the PRI would indicate that the operating unit has reached a certain minimum level of readiness to be considered for computation of PDI for one or more processes deployed by the unit along with other operating units already reporting PDI.

At block 602, the metrics are collected from operating units that have been newly added in an organization. For example, for the newly created operating unit, metrics 218 can be collected using collection agents 108 at each of the client devices 106. In one implementation, the metrics 218 can be collected periodically, such as on a weekly, monthly, quarterly basis or any other time interval.

At block 604, the metrics are analyzed. In one implementation, the analysis module 110, analyzes metrics 218. The analysis module 110 analyzes the metrics 218 associated with the newly added operating unit based on one or more rules and with respect to data stored in historical data 220.

At block 606, the PRI of the newly added operating unit is calculated. After analyzing metrics 218 of the new client device 102, the analysis module 110 calculates the PRI associated with one or more newly added operating units, and the processes deployed within the operating units. The calculated PRI value can lie in the range 1-10.

At block 608, a determination is made to check whether the calculated PRI is within threshold limits. For example, the analysis module 110 determines whether the PRI value of the newly added operating unit lies within a threshold limit. In one implementation, the threshold limits are defined in other data 224. In another implementation, the analysis module 110 can further associate the PRI with one or more visual indicators, such as color codes, etc. For example, a value of the PRI less than 4 can be depicted by color RED indicating a critical condition. Similarly, values between 4-8 and 9-10 can be depicted by colors AMBER and GREEN, respectively, to indicate an average and acceptable conditions.

If the calculated PRI is not within the acceptable limits (‘No’ path from block 608), one or more suggestive practices may be proposed for the newly added operating unit (block 610) to improve its performance. Subsequently, the method proceeds to block 606, which means that the unit continues to report PRI for some more time. For example, if a critical condition exists, individuals responsible for making management decisions may propose working practices to improve the PRI.

If the calculated PRI is within the acceptable limits (‘Yes’ path from block 608), the process for calculating the PDI is initiated (block 612). In one implementation, the analysis module 110 identifies the metrics 218 for the newly added operating unit, based on which the PDI would be evaluated. Once the process is initiated, the analysis module 110 also evaluates the PDI based on the identified metrics 218 for the newly added unit.

### CONCLUSION

Although embodiments for evaluating deployment of a process in an organization have been described in language specific to structural features and/or methods, it is to be understood that the invention is not necessarily limited to the specific features or methods described. Rather, the specific features and methods for evaluating deployment of a process are disclosed as exemplary implementations of the present invention.

I/We claim:

1. A computer implemented method for calculating a process deployment index, the method comprising:
collecting at least one metric value associated with at least one operating unit within an organization;
normalizing the at least one collected metric value to a common scale to obtain normalized metric values; and
calculating the process deployment index based on the normalized metric values, wherein the process deployment index is indicative of the extent of deployment of different processes within the organization.

2. The computer implemented method as claimed in claim 1, wherein the at least one metric value is associated with at least one process area implemented within the organization.

3. The computer implemented method as claimed in claim 1, wherein the at least one metric value is associated with at least one operating unit type.

4. The computer implemented method as claimed in claim 1, wherein the process deployment index is displayed to one or more stakeholders associated with the organization.

5. The computer implemented method as claimed in claim 1, further comprises verifying the correctness of the collected metric values based on a set of predefined rules.

6. The computer implemented method as claimed in claim 5, wherein the verifying comprises generating a request to re-enter the at least one of the collected metric value.

7. The computer implemented method as claimed in claim 1, further comprises comparing the process deployment index with one from a group consisting of pre-defined threshold limits and historically collected data.

8. The computer implemented method as claimed in claim 1, further comprises associating the process deployment index with visual indicators to represent poor, average, and acceptable performance of an underlying process.

9. The computer implemented method as claimed in claim 8, further comprises generating a critical indication using the visual indicator when the process deployment index exceeds at least one threshold limit.

10. The computer implemented method as claimed in claim 8, further comprises providing an indication when the process deployment index of a current reporting period varies with respect to process deployment index of a previous reporting period.

11. The computer implemented method as claimed in claim 8, further comprises generating a comparative analytics of the process deployment index for the at least one metric value over a predetermined time period based on statistical techniques.

12. A system for evaluating different processes comprising:
a processor;
a memory coupled to the processor, wherein the memory comprises,
a conversion module configured to convert metrics, associated with at least one operating unit within an organization, to a standard unit of measurement; and
an analysis module configured to analyze the metrics based on a set of rules.

13. The system as claimed in claim 12, wherein the conversion module is further configured to convert the metrics to a scale of 1-10.

14. The system as claimed in claim 12, wherein the analysis module is further configured to determine, based on rules and historical data, a process deployment index.

15. The system as claimed in claim 12, wherein the analysis module is further configured to display the process deployment index as one from a group consisting of bar graphs, pie charts, and color indications.

16. The system as claimed in claim 12, wherein the analysis module is configured to calculate the process deployment index value for a predetermined time period.

17. A computer-readable medium having embodied thereon a computer program for executing a method comprising:
collecting at least one metric value associated with at least one operating unit within an organization;
normalizing the at least one collected metric value to a common scale to obtain normalized metric values; and
calculating the process deployment index based on the normalized metric values, wherein the process deployment index is indicative of the extent of deployment of different processes within the organization.

18. The computer-readable medium as claimed in claim 17, wherein the process deployment value is calculated for a predetermined time period.

19. The computer-readable medium as claimed in claim 17, wherein the process deployment index is associated with visual indicators to represent poor, average, and acceptable performance of an underlying process.

20. The computer-readable medium as claimed in claim 17, wherein the calculating further comprising determining the process deployment index based on rules and historical data.
